(19) United States
(12) Patent Application Publication
(10) Pub. No.: US 2026/0363250 A1
(43) Pub. Date: Nov. 19, 2026

(54) A STABLE NON-AQUEOUS BIOPESTICIDE

(71) Applicants: UPL MAURITIUS LIMITED, Port Louis (MU); UPL EUROPE SUPPLY CHAIN GMBH, Rotkreuz / Risch (CH)

(72) Inventors: Gregory LECOLLINET, Saint-Malo (FR); Samantha BESSE, Pau (FR); Robert BURTON, Evesham (GB)

(73) Assignees: UPL MAURITIUS LIMITED, Port Louis (MU); UPL EUROPE SUPPLY CHAIN GMBH, Rotkreuz / Risch (CH)

(21) Appl. No.: 19/494,793

(22) PCT Filed: Mar. 28, 2024
(86) PCT No.: PCT/IB2024/053011

§ 371 Date: Dec. 18, 2025

(30) Foreign Application Priority Data
Mar. 28, 2023 (EP) 23305428.7

(51) Int. Cl. A01N 63/30; A01N 25/04; A01N 25/30; A01P 7/04

(52) U.S. Cl. CPC A01N 63/30; A01N 25/04; A01N 25/30; A01P 7/04

(57) ABSTRACT

The present invention relates to a biopesticide formulation of an entomopathogenic fungus or spores thereof. The present invention particularly discloses an oil dispersion comprising an entomopathogenic fungus or spores thereof, in particular Beauveria bassiana. The present invention also relates to the methods of preparation of the said formulation and uses thereof.

### FIELD OF INVENTION

The present invention relates to a biopesticide formulation. In particular, the present invention relates to a formulation of an entomopathogenic fungus or spores thereof.

The present invention also relates to the methods of preparation of the said formulation and uses thereof.

### BACKGROUND

Pests, such as insects, mites and ticks and nematodes, are a major problem for the agriculture industry, limiting productivity, often significantly. Although chemical pesticides are used to control pests, excessive use of chemical pesticides leaves residues in soil, water and air and also has adverse effects on the non-target organisms and the ecological balance. In addition, pests can develop resistance to chemical pesticides, limiting their effectiveness and application. Public concern over potential health hazards of chemical pesticides and the increase in cost of chemical pesticides has also led to the exploration of more eco-friendly pest management tactics.

Biopesticides have been developed for use as an alternative, or in some cases as a supplement, to chemical pesticides. Biopesticides are living organisms (e.g., fungi and bacteria) that intervene in the life cycle of pests (by killing or disabling the pest). As natural agents, biopesticides offer more eco-friendly solutions for controlling pests and/or for use in combination with chemical pesticide. Often biopesticides are found to clog nozzles on delivery devices and/or adhere to the inner surfaces of a delivery tank (often referred to as “staining”) because some biopesticides (such as fungal spores) are insoluble hydrophobic particles. Solutions have been to include surfactants in biopesticides formulations; however, many surfactants have been found to have phytotoxic effects on plants-including those of major agricultural importance. An important need exists for biopesticides formulations which have low phytotoxic effects on plants and are efficiently delivered and do not clog nozzles or adhere to the inner surfaces of delivery devices when being applied.

Biopesticides which comprise living microorganisms require a very stringent and precise set of selection conditions where maintenance of viability, a preferred physiological state and functional biological activity are key requirements to be met. As a result of the unique needs inherent in living biological systems, few surfactants, dispersing agents and related materials are known which perform satisfactorily, especially for commercial applications. Long term storage, maintenance of viability and high virulence are but a few of the required attributes for a commercial biological control product which have not been attainable heretofore with the known surfactants. Specifically, surfactants in general interfere with attachment and germination of spores, and no stable formulations of spores and surfactant are known since many fungi such as M. anisopliae and B. bassiana metabolize surfactants, detergents, wetting agents and similar materials. Within as brief a period as 72 hours, an aqueous suspension of spores in the presence of known surfactants will germinate and grow to form a mycelial mass which is useless for commercial insect control. Moreover, the spores of many entomopathogenic fungi by virtue of their hydrophobicity are refractory to mixing and dispersion in aqueous diluents. Clearly, the development of stable, efficacious, water-based fungal biocontrol products with broad spectrum activity and extended shelf-life has been almost nonexistent. Many of these problems are a result of inadequacies of the current formulation technology with regard to any biocontrol agents, particularly fungal agents.

In toto, the lack of biopesticidal compositions comprising ingredients compatible with viable microorganisms such as entomopathogenic fungi has negatively impacted areas as diverse as laboratory research (assay development), manufacturing (processing aids), formulations and commercial applications. The concentrations of surface-active agents which have been described in the literature as components of spore suspensions has not exceeded 0.5 percent (volume to volume for liquids; weight to volume for solids), and the reported duration of exposure has been limited to just a few hours. Longer exposure results in either loss of viability or germination and growth of the conidia to form the vegetative mycelial morphology.

### OBJECT OF INVENTION

While many solutions exist to control a variety of insect pests, a need remains for a formulation that will not only control insect pests, but one which can be efficiently delivered without having phytotoxic effects on plants when the formulation is applied. A formulation capable of being efficiently applied (e.g., without clogging and/or adherence of actives and/or other excipients to surfaces, etc.) to control pests, while having minimal, if any, environmental impact, or phytotoxic effects, is highly desirable. A stable formulation comprising ingredients which are compatible with the entomopathogenic fungi, and their spores is the need of the hour.

It is therefore an object of the present invention to provide materials useful in producing non-aqueous compositions of viable, monodispersed fungal spores with pesticidal activity, stable to both long- and short-term storage.

It is a still further object of this invention to provide a spore-compatible components such as an oil and surfactants for use in non-aqueous fungal formulations such as oil dispersion and other formulations.

It is another object of the present invention to provide materials that exhibit stability and are harmless to fungi and their spores, which do not inhibit germination after application or otherwise alter viability of fungi and their spores, that are useful in preserving spores.

It is still another object of the present invention to provide materials that are useful in manipulating and controlling spore viability and propagation.

### SUMMARY

In accordance with the objects of the invention, an aspect of the present disclosure provides a stable non-aqueous composition comprising:
a) an entomopathogenic fungus or spores thereof;
b) a vegetable oil; and
c) at least two non-ionic surfactants, wherein the non-ionic surfactants have a hydrophilic-lipophilic balance (HLB) value of 15 or less than 15.

In an aspect, the stable non-aqueous composition is an oil dispersion.

In an aspect, the entomopathogenic fungus or spores thereof is Beauveria bassiana or spores thereof.

In an aspect, the non-ionic surfactant(s) may be either water soluble non-ionic surfactants, water insoluble non-ionic surfactants, or a combination of a water-soluble non-ionic surfactant and a water insoluble non-ionic surfactant. In an aspect, the non-ionic surfactant(s) may be a non-ionic polymeric surfactant(s).

In an aspect, the compositions of the present disclosure comprise a combination of a non-ionic surfactant selected from a water-soluble non-ionic surfactant and a water insoluble non-ionic surfactant, and a non-ionic polymeric surfactant.

In an aspect, the non-ionic surfactants have a hydrophilic-lipophilic balance (HLB) value of 12 or less than 12. In a preferred embodiment, the non-ionic surfactants have a hydrophilic-lipophilic balance (HLB) value between 4 and 12. In another embodiment, one of the two non-ionic surfactants has HLB value in the range of 8 to 12 and the other non-ionic surfactant has HLB value in the range of 4 to 8.

In an aspect, the weight ratio of the two non-ionic surfactants in the composition ranges from 1:100 to 100:1.

An aspect of the present disclosure provides a stable non-aqueous composition comprising:
a) an entomopathogenic fungus or spores thereof in an amount ranging from about 0.1% w/w to about 30% w/w of the total weight of the composition;
b) a vegetable oil in an amount ranging from about 10% w/w to about 99.8% w/w of the total weight of the composition; and
c) at least two non-ionic surfactants in an amount ranging from about 0.1% w/w to about 60% w/w of the total weight of the composition, wherein the non-ionic surfactants have a hydrophilic-lipophilic balance (HLB) value of 15 or less than 15.

An aspect of the present disclosure provides a method of preparing a stable non-aqueous composition, wherein said method comprising the steps of:
i) Mixing a vegetable oil and at least two non-ionic surfactants having a hydrophilic-lipophilic balance (HLB) value of 15 or less than 15 under high shear;
ii) Adding an entomopathogenic fungus or spores thereof to the mixture obtained in step i);
iii) Homogenizing the mixture of step ii) to obtain a stable composition.

In an embodiment, said method comprises optionally adding a rheology modifier or an anionic surfactant under high shear to the mixture obtained in step i), prior to addition of entomopathogenic fungus or spores thereof.

An aspect of the present disclosure provides an oil dispersion obtainable by a method comprising:
i) Mixing a vegetable oil and at least two non-ionic surfactants having a hydrophilic-lipophilic balance (HLB) value of 15 or less than 15 under high shear;
ii) Adding an entomopathogenic fungus or spores thereof to the mixture obtained in step i);
iii) Homogenizing the mixture of step ii) to obtain a stable composition.

An aspect of the present disclosure provides a method of improving the storage stability and viability of an entomopathogenic fungus or spores thereof comprising preparing a non-aqueous composition comprising:
a) an entomopathogenic fungus or spores thereof;
b) a vegetable oil; and
c) at least two non-ionic surfactants, wherein the non-ionic surfactants have a hydrophilic-lipophilic balance (HLB) value of 15 or less than 15.

An aspect of the present disclosure provides a method of controlling plant pests, said method comprising contacting one or more plant pest with a composition comprising:
a) an entomopathogenic fungus or spores thereof;
b) a vegetable oil; and
c) at least two non-ionic surfactants, wherein the non-ionic surfactants have a hydrophilic-lipophilic balance (HLB) value of 15 or less than 15.

### DETAILED DESCRIPTION

As used herein, the singular forms “a”, “an” and “the” are intended to include the plural forms as well, unless the context clearly indicates otherwise. As used herein, the terms “active”, “active ingredient”, “agricultural active ingredient”, etc. mean any biological organism or chemical element, molecule, or compound, or mixture thereof, which has a biological activity in a seed, a plant, or a disease or pest of a seed or plant. Such active ingredients include, but are not limited to, pesticides, herbicides, fertilizers, plant growth regulators, drugs, dyes, biological attractants, scents and pheromones.

The biopesticides (i.e., the compositions) used in the embodiments disclosed herein comprise an agriculturally suitable carrier, a pesticidally effective amount of at least one fungal pesticide (e.g., as in two or more, such as two, three, four, five, six, seven, eight, nine, ten, etc.), and at least one surfactant (e.g., as in two or more, such as two, three, four, five, six, seven, eight, nine, ten, etc.). In a preferred embodiment, the at least one surfactant is selected from sorbitan fatty esters, sorbitol ethoxylates esters, alcohol ethoxylates and combinations thereof.

As used herein, the term “fungal pesticide” means a fungal organism, whether in a vegetative state or a dormant state (e.g., spore), that is pathogenic to a target pest, such as, an insect, Acari, or a nematode. As used herein, the terms “spore” has its normal meaning which is well known and understood by those of skill in the art and refers to a microorganism in its dormant, protected state.

As used herein, the term “entomopathogenic” means that the fungal pesticide is pathogenic to at least one target insect. As used herein, “entomopathogenic fungus” is a fungus that is capable of attacking, infecting, killing, disabling, causing disease, and/or causing injury to an insect, and is thus able to be used in the control insect infestation by adversely affecting the viability or growth of the target insect.

As used herein, “exogenously applied” means that the cuticle degrading enzyme is applied independently (that is, as a separate ingredient) from the compositions disclosed herein and any enzyme produced by fungal pesticide.

The term “pest” refers to any animal of the scientific classification (phylum) Arthropoda including Insecta, (e.g., white flies, thrips, weevils) and Arachnida, which includes but is not limited to, mites, ticks, spiders, and other like invertebrates.

As used herein, the term “control” or “controlling” as in e.g., the phrase: the “control” of pests or pest populations, or “controlling” pests or pest populations, or as in the phrase: “controlling” pests, refers to preventing, reducing, killing, inhibiting the growth of, or elimination of a pest or population of pests as defined herein. Indeed, “control” or “controlling” as used herein refers to any indicia of success in prevention, killing, inhibition, elimination, reduction or amelioration of a pest or pest population.

As used herein, the terms “effective amount”, “effective concentration”, or “effective dosage” are defined as the amount, concentration, or dosage of the fungal pesticide sufficient to cause infection in the pest which will then lead to the controlling of pests. The actual effective dosage in absolute value depends on factors including, but not limited to, the mortality rate of the target pests relative to the rate at which the fungal pesticide is applied, synergistic or antagonistic interactions between the other active or inert ingredients which may increase or reduce the activity of the fungal pesticide, the inherent susceptibility of the life stage and species of pest, and the stability of the fungal pesticide in compositions. The “effective amount”, “effective concentration”, or “effective dosage” of the fungal pesticide may be determined, e.g., by a routine dose response experiment. As used herein, the term “agriculturally beneficial ingredient(s)” is intended to mean any agent or combination of agents capable of causing or providing a beneficial and/or useful effect in agriculture. As used herein, the term “agriculturally beneficial microorganism(s)”, “agriculturally beneficial microbe”, “agriculturally beneficial bacteria”, etc. is intended to mean any microorganism (e.g., bacteria, fungus, etc., or combination thereof), regardless of whether the microorganism is in a vegetative state or spore form, that is capable of causing or providing a beneficial and/or useful effect in agriculture (e.g., enhancing plant growth, providing fungicidal activity, etc.).

As used herein, the terms “spore”, “microbial spore”, etc., has its normal meaning which is well known and understood by those of skill in the art. As used herein, the terms “spore” and “microbial spore” refer to a microorganism in its dormant, protected state.

As used herein, the term “inoculum” is intended to mean any form of microbial cells, or spores, which is capable of propagating on or in the soil when the conditions of temperature, moisture, etc., are favorable for microbial growth.

As used herein, the terms “plant(s)” and “plant part(s)” are intended to refer to all plants and plant populations such as desired and undesired wild plants or crop plants (including naturally occurring crop plants). Crop plants can be plants, which can be obtained by conventional plant breeding and optimization methods or by biotechnological and genetic engineering methods or by combinations of these methods, including the transgenic plants and including the plant cultivars protectable or not protectable by plant breeders' rights. Plant parts are to be understood as meaning all parts and organs of plants above and below the ground, such as shoot, leaf, flower and root, examples which may be mentioned being leaves, needles, stalks, stems, flowers, fruit bodies, fruits, seeds, roots, tubers, and rhizomes. The plant parts also include harvested material and vegetative and generative propagation material (e.g., cuttings, tubers, rhizomes, off-shoots and seeds, etc.).

As used herein, the term “foliage” is intended to mean all parts and organs of plants above the ground. Non-limiting examples include leaves, needles, stalks, stems, flowers, fruit bodies, fruits, etc. As used herein, the term “foliar application”, “foliarly applied”, and variations thereof, is intended to include application of an active ingredient to the foliage or above ground portions of the plant, (e.g., the leaves of the plant). Application may be effected by any means known in the art (e.g., spraying the active ingredient).

As used herein, the term “source” of a particular element is intended to mean a compound of that element which, at least in the soil conditions under consideration, does not make the element fully available for plant uptake.

As used herein, the term “nutrient(s)” is intended to refer to any nutrient (e.g., vitamins, macrominerals, micronutrients, trace minerals, organic acids, etc.) which are needed for plant growth, plant health, and/or plant development.

As used herein, the term “herbicide(s)” is intended to refer to any agent or combination of agents capable of killing weeds and/or inhibiting the growth of weeds (the inhibition being reversible under certain conditions).

As used herein, the term “fungicide(s)” is intended to refer to any agent or combination of agents capable of killing fungi and/or inhibiting fungal growth.

As used herein, the term “insecticide(s)” is intended to refer to any agent or combination of agents capable of killing one or more insects and/or inhibiting the growth of one or more insects.

As used herein, the term “nematicide(s)” is intended to refer to any agent or combination of agents capable of killing one or more nematodes and/or inhibiting the growth of one or more nematodes.

As used herein, the term “acaricide(s)” is intended to refer to any agent or combination of agents capable of killing one or more acarids and/or inhibiting the growth of one or more acarids. As used herein, the term “biostimulant(s)” is intended to refer to any agent or combination of agents capable of enhancing metabolic or physiological processes within plants and soils.

As used throughout this specification, the terms “parts by weight” or “percentage weight” are used interchangeably in the specification wherein the weight percentages of each of the individual constituents are indicated in weight percent based on the total weight of the particular composition of which it forms a part.

The inventors found that fungal spore formulations, which are often suspended in oil, do not disperse well when diluted with water. Without being bound by theory, it is believed that if the oil phase is poorly dispersed, oil droplets will increase in size and the hydrophobic fungal spores will be attracted to the droplets and/or locate entirely inside the oil droplets.

These droplets are attracted to the inner walls/surfaces of sprayer tanks (i.e., especially plastic containers often used in the agricultural industry) causing poor and inefficient dispersion of the actives (e.g., the fungal spores), clogging of the spraying equipment (e.g., the nozzles or hoses), and difficulty in cleaning tanks and other spray or delivery equipment. To eliminate this problem, a variety of surfactant systems were applied; however, phytotoxicity remains a problem. The inventors discovered, surprisingly and unexpectedly, that the proper combination of surfactants at particular ratios, often very small amounts of one surfactant relative to another, would decrease the overall phytotoxicity of a particular formulation while simultaneously overcoming known challenges encountered when trying to adequately deliver the active ingredients when diluted with water and applied.

It is further believed that by modifying the carrier to increase the dispersion and/or suspension of the biopesticide in an aqueous solution, that the biopesticide will be able to be delivered efficiently (e.g., through a sprayer) without actives adhering/sticking to the inner walls of the delivery device or clogging the delivery components (e.g., sprayer nozzles, sprayer tubing, etc.).

Suitable surfactants for the biopesticides disclosed herein will have minimal, if any negative effects, on the viability of the fungal pesticides.

Accordingly, disclosed herein are compositions which act as biopesticides and methods which offer an improved and practical approach to controlling damage caused to crops by pest populations. The biopesticides described herein will have the benefit of controlling pests but also have the added benefits of being efficiently delivered when fully formulated (i.e., actives and/or other excipients will not be retained within the inside of a holding tank, e.g., reduced adherence/sticking of actives and/or other excipients to the inner surfaces of the a tank, or clog the delivery apparatus or parts thereof e.g., the nozzles or hoses of the delivery device) and cause minimal, if any, phytotoxic injury to the crops treated with the fully formulated biopesticide.

In an embodiment, the present disclosure provides a stable non-aqueous composition comprising:
a) an entomopathogenic fungus or spores thereof;
b) a vegetable oil; and
c) at least two non-ionic surfactants, wherein the non-ionic surfactants have a hydrophilic-lipophilic balance (HLB) value of 15 or less than 15.

In a preferred embodiment, the stable non-aqueous composition is an oil dispersion.

In an embodiment, said composition is a fungal pesticide composition. In an embodiment, the spores of an entomopathogenic fungus act as a fungal pesticide. In an embodiment, the said composition is a biopesticide composition comprising a fungal pesticide.

In an embodiment, the spores of an entomopathogenic fungus belongs to the genera Ascomycota, Alternaria, Beauveria, Lecanicillium, Metarhizium, Verticillium, Trichoderma, Aspergillus, Nomuraea, Paecilomyces, Isaria, Hirsutella, Fusarium, Cordyceps, Entomophthora, Zoophthora, Pandora, Entomophaga, Entomophthorales, Zygomycota and combinations thereof.

In one embodiment, non-limiting examples of entomopathogenic fungus that may be used in the compositions disclosed herein include species of Coelomycidium, Myiophagus, Coelemomyces, Lagenidium, Leptolegnia, Couchia, Sporodiniella, Conidiobolus, Entomophaga, Entomophthora, Erynia, Massospora, Meristacrum, Neozygites, Pandora, Zoophthora, Blastodendrion, Metschnikowia, Mycoderma, Ascophaera, Cordyceps, Torrubiella, Nectria, Hypocrella, Calonectria, Filariomyces, Hesperomyces, Trenomyces, Myriangium, Podonectria, Akanthomyces, Aschersonia, Aspergillus, Beauveria, Culicinomyces, Engyodontium, Fusarium, Gibellula, Hirsutella, Hymenostilbe, Isaria, Metarhizium, Nomuraea, Paecilomyces, Paraisaria, Pleurodesmospora, Polycephalomyces, Pseudogibellula, Sorosporella, Stillbella, Tetranacrium, Tilachlidium, Tolypocladium, Verticillium, Aegerita, Filobasidiella, Septobasidium, Uredinella, and combinations thereof.

In an embodiment, the non-limiting examples of entomopathogenic fungus species that may be useful as a fungal pesticide in the biopesticides described herein include Trichoderma hamatum, Trichoderma hazarium, Alternana cassiae, Fusarium lateritum, Fusarium solani, Lecanicillium lecanii, Aspergillus parasiticus, Verticillium lecanii, Metarhizium anisopliae, and Beauveria bassiana. In an embodiment, the compositions disclosed herein may include any of the fungal pesticides provided above, including any combination thereof. In another embodiment, the fungal pesticide is stable so that the fungal pesticide retains a sufficient effective amount of activity when used. In one embodiment, the fungal pesticide is present in the composition in the form of stable spores.

In yet another embodiment the entomopathogenic fungus comprises at least one fungal pesticide from the genus Beauveria spp., such as, for example, Beauveria bassiana. In at least one embodiment, the entomopathogenic fungus comprises the strain Beauveria bassiana. In another embodiment, the entomopathogenic fungus further comprises spores of the strain Beauveria bassiana. A person skilled in the art would comprehend that the composition of the present invention can comprise any strain of Beauveria bassiana or spores of any strain of Beauveria bassiana and the invention is not particularly limited to the strain used.

In a preferred embodiment, the entomopathogenic fungus comprises at least one fungal pesticide comprising Beauveria bassiana TK. In another embodiment, the entomopathogenic fungus comprises at least one fungal pesticide comprising spores of Beauveria bassiana TK. In a preferred embodiment, the entomopathogenic fungus comprises at least one fungal pesticide comprising Beauveria bassiana strain ATCC-74040. In another embodiment, the entomopathogenic fungus comprises at least one fungal pesticide comprising spores of Beauveria bassiana strain ATCC-74040. In another embodiment, the entomopathogenic fungus comprises at least one fungal pesticide comprising Beauveria bassiana strain ATCC-74250. In another embodiment, the entomopathogenic fungus comprises at least one fungal pesticide comprising Beauveria bassiana strain CNCM I-867. In another embodiment, the entomopathogenic fungus comprises at least one fungal pesticide comprising Beauveria bassiana strain CNCM I-2960. In still another embodiment, the entomopathogenic fungus comprises at least one fungal pesticide comprising spores of Beauveria bassiana strain ATCC-74250. In still another embodiment, the entomopathogenic fungus comprises at least one fungal pesticide comprising spores of Beauveria bassiana strain CNCM I-867. In still another embodiment, the entomopathogenic fungus comprises at least one fungal pesticide comprising spores of Beauveria bassiana strain CNCM I-2960. In yet another embodiment, the entomopathogenic fungus comprises at least one fungal pesticide comprising a mixture of Beauveria bassiana strain ATCC-74040 and Beauveria bassiana strain ATCC-74250. In still another embodiment, the entomopathogenic fungus comprises at least one fungal pesticide comprising a mixture of spores of Beauveria bassiana strain ATCC-74040 and Beauveria bassiana strain ATCC-74250. In yet another embodiment, the entomopathogenic fungus comprises at least one fungal pesticide comprising a mixture of Beauveria bassiana strain CNCM I-867 and Beauveria bassiana strain CNCM I-2960. In still another embodiment, the entomopathogenic fungus comprises at least one fungal pesticide comprising a mixture of spores of Beauveria bassiana strain CNCM I-867 and Beauveria bassiana strain CNCM I-2960. In another embodiment, the entomopathogenic fungus described herein may comprise a combination of various strains of Beauveria bassiana or spores of various strains of Beauveria bassiana. In another embodiment, the entomopathogenic fungus described herein may comprise a combination of fungi. In one embodiment, the entomopathogenic fungus may comprise two or more fungal pesticides that are different strains of the same species. In another embodiment, the entomopathogenic fungus comprises at least two different fungal pesticides that are strains of different species.

In an embodiment, the vegetable oil is selected from olive oil, kapok oil, castor oil, palm oil, sunflower oil, camellia oil, coconut oil, sesame oil, corn oil, rice bran oil, peanut oil, cottonseed oil, soybean oil, rapeseed oil, linseed oil, tung oil, canola oil, corn oil, or combinations thereof. In a preferred embodiment, the vegetable oil is sunflower oil. In a preferred embodiment, the vegetable oil is corn oil. In a preferred embodiment, the vegetable oil is soybean oil.

The composition described herein may comprise at least two non-ionic surfactants having a hydrophilic-lipophilic balance (HLB) value of 15 or less than 15. In an embodiment, the non-ionic surfactants have a hydrophilic-lipophilic balance (HLB) value of 12 or less than 12. In a preferred embodiment, the non-ionic surfactants have a hydrophilic-lipophilic balance (HLB) value between 4 and 12. In another embodiment, one of the two non-ionic surfactants has HLB value in the range of 8 to 12 and the other non-ionic surfactant has HLB value in the range of 4 to 8.

In an embodiment, the non-ionic surfactants are selected from water soluble non-ionic surfactants, water insoluble non-ionic surfactants, non-ionic polymeric surfactants, or combinations thereof.

In an embodiment, the non-ionic surfactants may be either water soluble non-ionic surfactants, water insoluble non-ionic surfactants, or a combination of a water-soluble non-ionic surfactant and a water insoluble non-ionic surfactant. In an embodiment, the water-soluble non-ionic surfactants, water insoluble non-ionic surfactants have an HLB value of 15 or less than 15, preferably 12 or less than 12. In an embodiment, the water-soluble non-ionic surfactants, water insoluble non-ionic surfactants have an HLB value in the range of 4 and 12. In another embodiment, the preferred HLB value for water insoluble non-ionic surfactants is in the range of 8 to 12. In another embodiment, the preferred HLB value for water insoluble non-ionic surfactants is 10.

In an embodiment, the non-ionic surfactant(s) may be a non-ionic polymeric surfactant(s). In an embodiment, the non-ionic polymeric surfactant has an HLB value of 15 or less than 15, preferably 12 or less than 12. In an embodiment, the non-ionic polymeric surfactant has an HLB value in the range of 4 and 12. In another embodiment, the preferred HLB value for the non-ionic polymeric surfactant is in the range of 4 to 8. In another embodiment, the preferred HLB value for the non-ionic polymeric surfactant is 6.

In an embodiment, the compositions of the present disclosure comprise at least two non-ionic surfactants. In another embodiment, the compositions comprise at least two water insoluble non-ionic surfactants. In another embodiment, the compositions comprise at least two water soluble non-ionic surfactants. In yet another embodiment, the compositions comprise at least two non-ionic polymeric surfactants.

In an embodiment, the compositions comprise one or more water insoluble non-ionic surfactants. In yet another embodiment, the compositions comprise one or more water soluble non-ionic surfactants. In another embodiment, the compositions comprise one or more non-ionic polymeric surfactants. In still another embodiment, the compositions comprise one or more water insoluble non-ionic surfactants and one or more water soluble non-ionic surfactants. In another embodiment, the compositions comprise one or more water insoluble non-ionic surfactants and one or more non-ionic polymeric surfactants. In another embodiment, the compositions comprise one or more water soluble non-ionic surfactants and one or more non-ionic polymeric surfactants.

The following table illustrates the surfactants of the composition. The at least two non-ionic surfactants are illustrated as Surfactant 1 and Surfactant 2 and their respective HLB values are provided therein.

| Surfactant 1 | Surfactant 2 | HLB value of surfactant 1 | HLB value of surfactant 2 |
|---|---|---|---|
| water insoluble | water insoluble non- | 15 or less than 15, preferably | 15 or less than 15, |
| non-ionic | ionic surfactant, | 12 or less than 12, more | preferably 12 or less than |
| surfactant | proviso Surfactant 2 | preferably in the range of 4 | 12, more preferably in the |
| | is different from | and 12, even more | range of 4 and 12 |
| | Surfactant 1 | preferably in the range of 8 | |
| | | to 12 | |
| water insoluble | water soluble non- | 15 or less than 15, preferably | 15 or less than 15, |
| non-ionic | ionic surfactant | 12 or less than 12, more | preferably 12 or less than |
| surfactant | | preferably in the range of 4 | 12, more preferably in the |
| | | and 12, even more | range of 4 and 12 |
| | | preferably in the range of 8 | |
| | | to 12 | |
| water insoluble | non-ionic polymeric | 15 or less than 15, preferably | 15 or less than 15, |
| non-ionic | surfactant | 12 or less than 12, more | preferably 12 or less than |
| surfactant | | preferably in the range of 4 | 12, more preferably in the |
| | | and 12, even more | range of 4 and 12, even |
| | | preferably in the range of 8 | more preferably in the range |
| | | to 12 | of 4 to 8 |
| water soluble | water soluble non- | 15 or less than 15, preferably | 15 or less than 15, |
| non-ionic | ionic surfactant, | 12 or less than 12, more | preferably 12 or less than |
| surfactant | proviso Surfactant 2 | preferably in the range of 4 | 12, more preferably in the |
| | is different from | and 12 | range of 4 and 12 |
| | Surfactant 1 | | |
| water soluble | non-ionic polymeric | 15 or less than 15, preferably | 15 or less than 15, |
| non-ionic | surfactant | 12 or less than 12, more | preferably 12 or less than |
| surfactant | | preferably in the range of 4 | 12, more preferably in the |
| | | and 12 | range of 4 and 12, even |
| | | | more preferably in the range |
| | | | of 4 to 8 |
| non-ionic | non-ionic polymeric | 15 or less than 15, preferably | 15 or less than 15, |
| polymeric | surfactant, proviso | 12 or less than 12, more | preferably 12 or less than |
| surfactant | Surfactant 2 is | preferably in the range of 4 | 12, more preferably in the |
| | different from | and 12, even more | range of 4 and 12 |
| | Surfactant 1 | preferably in the range of 4 | |
| | | to 8 | |

In an embodiment, the compositions of the present disclosure comprise a combination of a non-ionic surfactant selected from a water-soluble non-ionic surfactant and a water insoluble non-ionic surfactant, and a non-ionic polymeric surfactant. In an embodiment, the HLB value of the non-ionic surfactants is in a range of 4 to 12. In a preferred embodiment, the HLB value for water insoluble non-ionic surfactants is in the range of 8 to 12. In a preferred embodiment, the preferred HLB value for the non-ionic polymeric surfactant is 6.

In an embodiment, the compositions of the present disclosure comprise a combination of a water insoluble non-ionic surfactant and a non-ionic polymeric surfactant.

In an embodiment, non-ionic surfactant(s) of the composition are a combination of a water soluble non-ionic surfactant and a non-ionic polymeric surfactant.

In a preferred embodiment, the non-ionic polymeric surfactants are selected from polyalkylene oxide block copolymers, butyl block copolymers, non-ionic block copolymers, acrylic copolymer solutions, non-ionic random polymeric polymers, polyoxyethylene polyarl phenols, non-ionic polymeric dispersants, polyisobutylene succinic anhydride-polyethylene glycol and combinations thereof. In a more preferred embodiment, the composition comprises one or more non-ionic polymeric surfactants selected from polyisobutylene succinic anhydride-polyethylene glycol, polyalkylene oxide block copolymer, polyalkylene glycol ether, polyoxyalkylene glycol fatty alcohol ether, polyoxyethylene alkyl ether, block copolymer of polyethylene glycol and 12-hydroxystearic acid, polymethyl methacrylate-polyethylene glycol graft copolymer, succinic anhydride-polyethylene glycol, polyoxyethylene polyaryl phenol, block copolymer of a poly(12-hydroxystearic acid) and poly(ethylene oxide), block copolymer of a poly(12-hydroxystearic acid) and poly(ethylene oxide) (also known as polyethylene glycol) having molecular weights from 1500 to 10000, alkylbenzenesulphonates, alkanoyl taurates, and alkanoyl sarcosinates, and combinations thereof.

In an embodiment, the water insoluble non-ionic surfactants are selected from alkyl and aryl: glycerol ethers, glycol ethers, ethanolamides, sulfoanylamides, alcohols, amides, alcohol ethoxylates, exthoxylated oil such as castor oil ethoxylates, glycerol esters, glycol esters, ethoxylates of glycerol ester and glycol esters, sugar-based alkyl polyglycosides, polyoxyethylenated fatty acids, alkanolamine condensates, alkanolamides, tertiary acetylenic glycols, polyoxyethylenated mercaptans, carboxylic acid esters, polyoxyethylenated polyoxyproylene glycols, sorbitan fatty acid esters, sorbitol ethoxylate esters, EO/PO block copolymers (EO is ethylene oxide, PO is propylene oxide), EO polymers and copolymers, polyamines, polyvinylpyrrolidones, sulfosuccinates such as sodium dioctyl sulfosuccinate, and combinations thereof.

Non-limiting examples of commercially available water insoluble non-ionic surfactants that may be suitable for the composition described herein include polyoxyethylene (30) oleate-laurates, polyoxyethylene (40) sorbitol hexaoleate, polyoxyethylene (50) sorbitol hexaoleates, alcohol ethoxylates, sorbitan fatty acid esters, polyoxyethylene (40) sorbitol oleates, and combinations thereof.

In one embodiment, the compositions of the present disclosure comprise at least one water insoluble non-ionic surfactant. In another embodiment, the compositions of the present disclosure comprise at least one water insoluble non-ionic surfactant selected from sorbitan fatty acid esters, sorbitol ethoxylate esters and combinations thereof. Non-limiting examples of sorbitan fatty acid esters that may be suitable for the compositions of the present disclosure include sorbitan monolaurates, sorbitan monopalmitates, sorbitan monostearates, sorbitan tristearates, sorbitan monooleates, sorbitan trioleates, and combinations thereof. Non-limiting examples of sorbitol ethoxylates esters that may be suitable for the compositions of the present disclosure include polyoxyethylene (40) sorbitol oleates, polyoxyethylene (40) sorbitol hexaoleates, polyoxyethylene (50) sorbitol hexaoleates, polyoxyethylene (30) oleate-laurates, polyoxyethylenesorbitan monolaurate, and combinations thereof.

In another preferred embodiment, the compositions comprise one or more sorbitan fatty esters selected from a sorbitan monolaurate, a sorbitan monopalmitate, a sorbitan monostearate, a sorbitan tristearate, a sorbitan monooleate, a sorbitan trioleate, and combinations thereof. In still another preferred embodiment, the compositions comprise one or more sorbitol ethoxylates esters selected from a polyoxyethylene (40) sorbitol oleate, a polyoxyethylene (40) sorbitol hexaoleate, a polyoxyethylene (50) sorbitol hexaoleate, a polyoxyethylene (30) oleate-laurate, and combinations thereof.

In yet another preferred embodiment, the composition comprises at least one sorbitan fatty acid ester, wherein the sorbitan fatty ester is selected from a sorbitan monolaurate, a sorbitan monopalmitate, a sorbitan monostearate, a sorbitan tristearate, a sorbitan monooleate, a sorbitan trioleate, and combinations thereof, and a sorbitol ethoxylate ester, wherein the sorbitol ethoxylates ester is selected from a polyoxyethylene (40) sorbitol oleate, a polyoxyethylene (40) sorbitol hexaoleate, a polyoxyethylene (50) sorbitol hexaoleate, a polyoxyethylene (30) oleate-laurate, and combinations thereof.

In another embodiment, the composition comprises a sorbitan monostearate. In still another embodiment, the composition comprises a sorbitan monooleate. In still yet another embodiment, the composition comprises a polyoxyethylene sorbitol hexaoleate. In still yet another embodiment, the composition comprises a polyoxyethylene (40) sorbitol hexaoleate. In a preferred embodiment, the composition comprises a sorbitan monostearate, a sorbitan monooleate, a polyoxyethylene (40) sorbitol hexaoleate, and combinations thereof. In another preferred embodiment, the composition comprises a sorbitan monostearate, a sorbitan monooleate, and combinations thereof. In yet another preferred embodiment, the composition comprises a sorbitan monostearate, a polyoxyethylene (40) sorbitol hexaoleate, and combinations thereof. In still another preferred embodiment, the composition comprises a sorbitan monooleate, a polyoxyethylene (40) sorbitol hexaoleate, and combinations thereof.

In an embodiment, the water-soluble non-ionic surfactants are selected from sorbitan fatty acid alcohol ethoxylates, alkoxylated diethylethanolamine, sorbitan fatty acid ester ethoxylates, and combinations thereof. In one embodiment, the composition comprises at least one water soluble non-ionic surfactant that is a linear primary, or secondary or branched alcohol ethoxylate having the formula: RO(CH₂CH₂O)nH, wherein R is the hydrocarbon chain length and n is the average number of moles of ethylene oxide. In an embodiment, R can be a linear primary, or secondary, or branched alcohol ethoxylates having a hydrocarbon chain length in the range from C9 to C16 and n ranges from 6 to 13. In another embodiment the composition comprises at least one alcohol ethoxylate where R is linear C9-C11 hydrocarbon chain length, and n is 6. In still another embodiment, when the compositions of the present disclosure comprise more than one water soluble surfactant, the water soluble surfactants are of substantially the same carbon chain length.

In an embodiment, the commercially available water soluble non-ionic surfactants that may be suitable for the compositions of the present disclosure include alcohol ethoxylates, polyoxyethylene sorbitol ester, polyoxyethylene (4) sorbitan monolaurate, polyoxyethylene-sorbitan-monopalmitate, polyoxyethylene (20) sorbitan monostearate, polyethylene sorbitol ester, polyoxyethylene (20) sorbitan monooleate, 22-mole ethoxylate of linear primary 12-14 carbon number alcohol, and combinations thereof.

In one embodiment, the compositions of the present disclosure comprise at least one water soluble non-ionic surfactant selected from the group consisting of alcohol ethoxylates, polyoxyethylene sorbitol ester, polyoxyethylene (4) sorbitan monolaurate, polyoxyethylene-sorbitan-monopalmitate, polyoxyethylene (20) sorbitan monostearate, polyethylene sorbitol ester, polyoxyethylene (20) sorbitan monooleate, 22-mole ethoxylate of linear primary 12-14 carbon number alcohol, and combinations thereof.

In a preferred embodiment, the compositions of the present disclosure comprise at least one sorbitan fatty acid ester ethoxylate selected from the group consisting of alcohol ethoxylates, polyoxyethylene sorbitol ester, polyoxyethylene (4) sorbitan monolaurate, polyoxyethylene-sorbitan-monopalmitate, polyoxyethylene (20) sorbitan monostearate, polyethylene sorbitol ester, polyoxyethylene (20) sorbitan monooleate, 22-mole ethoxylate of linear primary 12-14 carbon number alcohol, and combinations thereof.

In still another embodiment, the compositions of the present disclosure comprise at least one alcohol ethoxylate, at least one sorbitan fatty acid ester ethoxylate, or a combination thereof. In still another embodiment, the compositions of the present disclosure comprise at least one water soluble non-ionic surfactant selected from the group consisting of alcohol ethoxylates, polyoxyethylene sorbitol ester, polyoxyethylene (4) sorbitan monolaurate, polyoxyethylene-sorbitan-monopalmitate, polyoxyethylene (20) sorbitan monostearate, polyethylene sorbitol ester, polyoxyethylene (20) sorbitan monooleate, 22-mole ethoxylate of linear primary 12-14 carbon number alcohol, and combinations thereof.

In an embodiment, the weight ratio of the two non-ionic surfactants in the composition ranges from 1:100 to 100:1. In an embodiment, the weight ratio of the two non-ionic surfactants in the composition ranges from 1:50 to 50:1. In an embodiment, the weight ratio of the two non-ionic surfactants in the composition ranges from 1:20 to 20:1. In an embodiment, the weight ratio of the two non-ionic surfactants in the composition ranges from 1:10 to 10:1. In an embodiment, the weight ratio of the two non-ionic surfactants in the composition ranges from 1:7.5 to 7.5:1. In an embodiment, the weight ratio of the two non-ionic surfactants in the composition ranges from 1:5 to 5:1. In an embodiment, the weight ratio of the two non-ionic surfactants in the composition ranges from 1:3 to 3:1.

In an embodiment, the compositions of the present disclosure comprise one or more non-ionic surfactants selected from a water-soluble non-ionic surfactant and a water insoluble non-ionic surfactant; and one or more non-ionic polymeric surfactants, wherein the non-ionic surfactants have an HLB value in the range of 4 and 12.

In an embodiment, the entomopathogenic fungus or spores thereof constitutes about 0.1% w/w to about 30% w/w of the total weight of the composition. In a preferred embodiment, the entomopathogenic fungus or spores thereof constitutes about 0.5% w/w to about 20% w/w of the total weight of the composition. In still another embodiment, the entomopathogenic fungus or spores thereof constitutes about 0.7% w/w to about 10% w/w of the total weight of the composition. In yet another embodiment, the entomopathogenic fungus or spores thereof constitutes about 1% w/w to about 5% w/w of the total weight of the composition.

In an embodiment, the Beauveria bassiana or spores thereof constitutes about 0.1% w/w to about 30% w/w of the total weight of the composition. In a preferred embodiment, the Beauveria bassiana or spores thereof constitutes about 0.5% w/w to about 20% w/w of the total weight of the composition. In still another embodiment, the Beauveria bassiana or spores thereof constitutes about 0.7% w/w to about 10% w/w of the total weight of the composition. In yet another embodiment, the Beauveria bassiana or spores thereof constitutes about 1% w/w to about 5% w/w of the total weight of the composition. In an embodiment, the composition comprises about 1×10⁷ CFU to about 1×10¹¹ CFU of Beauveria bassiana spores. In a preferred embodiment, the composition comprises about 1×10⁹ CFU of Beauveria bassiana spores.

In an embodiment, the vegetable oil constitutes about 10% w/w to about 99.8% w/w of the total weight of the composition. In a preferred embodiment, the vegetable oil constitutes about 20% w/w to about 99% w/w of the total weight of the composition. In a preferred embodiment, the vegetable oil constitutes about 30% w/w to about 90% w/w of the total weight of the composition. In a preferred embodiment, the vegetable oil constitutes about 40% w/w to about 85% w/w of the total weight of the composition. In a preferred embodiment, the vegetable oil constitutes about 50% w/w to about 80% w/w of the total weight of the composition. In a preferred embodiment, the vegetable oil constitutes about 60% w/w to about 85% w/w of the total weight of the composition. In a preferred embodiment, the vegetable oil constitutes about 60% w/w to about 75% w/w of the total weight of the composition.

In an embodiment, the sunflower oil constitutes about 10% w/w to about 99.8% w/w of the total weight of the composition. In a preferred embodiment, the sunflower oil constitutes about 20% w/w to about 99% w/w of the total weight of the composition. In a preferred embodiment, the sunflower oil constitutes about 30% w/w to about 90% w/w of the total weight of the composition. In a preferred embodiment, the sunflower oil constitutes about 40% w/w to about 85% w/w of the total weight of the composition. In a preferred embodiment, the sunflower oil constitutes about 50% w/w to about 80% w/w of the total weight of the composition. In a preferred embodiment, the sunflower oil constitutes about 60% w/w to about 85% w/w of the total weight of the composition. In a preferred embodiment, the sunflower oil constitutes about 60% w/w to about 75% w/w of the total weight of the composition.

In an embodiment, the non-ionic surfactant constitutes about 0.1% w/w to about 60% w/w of the total weight of the composition. In a preferred embodiment, the non-ionic surfactant constitutes about 0.5% w/w to about 50% w/w of the total weight of the composition. In still another embodiment, the non-ionic surfactant thereof constitutes about 1% w/w to about 40% w/w of the total weight of the composition. In yet another embodiment, the non-ionic surfactant constitutes about 1.5% w/w to about 30% w/w of the total weight of the composition.

In an embodiment, the water insoluble non-ionic surfactant constitutes about 0.1% w/w to about 60% w/w of the total weight of the composition. In a preferred embodiment, the water insoluble non-ionic surfactant constitutes about 0.5% w/w to about 50% w/w of the total weight of the composition. In still another embodiment, the water insoluble non-ionic surfactant thereof constitutes about 1% w/w to about 40% w/w of the total weight of the composition. In yet another embodiment, the water insoluble non-ionic surfactant constitutes about 2% w/w to about 30% w/w of the total weight of the composition. In yet another embodiment, the water insoluble non-ionic surfactant constitutes about 5% w/w to about 25% w/w of the total weight of the composition.

In an embodiment, the non-ionic polymeric surfactant constitutes about 0.1% w/w to about 60% w/w of the total weight of the composition. In a preferred embodiment, the non-ionic polymeric surfactant constitutes about 0.5% w/w to about 50% w/w of the total weight of the composition. In still another embodiment, the non-ionic polymeric surfactant thereof constitutes about 1% w/w to about 40% w/w of the total weight of the composition. In yet another embodiment, the non-ionic polymeric surfactant constitutes about 1% w/w to about 30% w/w of the total weight of the composition. In yet another embodiment, the non-ionic polymeric surfactant constitutes about 1% w/w to about 20% w/w of the total weight of the composition. In yet another embodiment, the non-ionic polymeric surfactant constitutes about 1% w/w to about 10% w/w of the total weight of the composition. In yet another embodiment, the non-ionic polymeric surfactant constitutes about 1% w/w to about 5% w/w of the total weight of the composition.

The compositions of the present disclosure may further comprise one or more optional ingredients that are physically and/or chemically compatible with the components embodied herein. Non-limiting optional ingredients include, anti-settling agents (rheological additives, also called rheology modifiers in the present disclosure), agriculturally beneficial ingredients (e.g., enzymes, beneficial plant signal molecules, beneficial microorganisms, insecticides, fungicides, nematicides, nutrients, etc.), insect growth regulators, electrostatic carriers, preservatives, fillers, pH adjusting agents, stabilizers, builders, buffers, antioxidants, water absorbing agents, foams, humectants, wetting agents UV protectants, solvents, nutritive additives, and combinations thereof. Such ingredients are known to those skilled in the art.

In at least one embodiment, the compositions of the present disclosure may optionally comprise one or more anti-settling agents/rheology modifiers. Alternatively, the one or more anti-settling agents may be applied either simultaneously or applied sequentially, with the biopesticides disclosed herein. The one or more anti-settling agents may comprise any agent capable of maintaining insoluble particles (i.e., fungal pesticide spores) uniformly suspended in liquid solution (i.e., prevent insoluble from settling).

Non-limiting examples of anti-settling agents that may be suitable for the compositions of the present disclosure polyvinyl acetate, polyvinyl alcohols with different degrees of hydrolysis, polyvinylpyrrolidones, polyacrylates, acrylate-, polyol- or polyester-based paint system binders which are soluble or dispersible in water, moreover copolymers of two or more monomers such as acrylic acid, methacrylic acid, itaconic acid, maleic acid, fumaric acid, maleic anhydride, vinylpyrrolidone, ethylenically unsaturated monomers such as ethylene, butadiene, isoprene, chloroprene, styrene, divinylbenzene, ot-methylstyrene or p-methylstyrene, further vinyl halides such as vinyl chloride and vinylidene chloride, additionally vinyl esters such as vinyl acetate, vinyl propionate or vinyl stearate, moreover vinyl methyl ketone or esters of acrylic acid or methacrylic acid with monohydric alcohols or polyols such as methyl acrylate, methyl methacrylate, ethyl acrylate, ethylene methacrylate, lauryl acrylate, lauryl methacrylate, decyl acrylate, N,N-dimethylamino-ethyl methacrylate, 2-hydroxyethyl methacrylate, 2-hydroxypropyl methacrylate or glycidyl methacrylate, furthermore diethyl esters or monoesters of unsaturated dicarboxylic acids, furthermore (meth)acrylamido-N-methylol methyl ether, amides or nitriles such as acrylamide, methacrylamide, N-methylol (meth)acrylamide, acrylonitrile, methacrylonitrile, and also N-substituted maleiraides and ethers such as vinyl butyl ether, vinyl isobutyl ether or vinyl phenyl ether, and combinations thereof. In another embodiment, the gelling agents which may be used as rheology modifier or antisettling agent include hydrophobically-modified clays (e.g., sodium montmorillonite where exchangeable sodium ions are replaced with organic cationic molecules, such as, alkylamines), surface modified silicas, fumed silicas (e.g., untreated, or surface-modified), and combinations thereof. Surface-modified fumed silicas include, for example, fumed silicas surface-modified with hexamethyldisilazane, dimethyldichlorosilane (DiMeDi), polydimethylsiloxane, hydrophobic fumed silica after-treated with DDS. (dimethyldichlorosilane), etc.

In an embodiment, the composition comprises an optional anti-settling agent/rheology modifier. Rheology modifier may be selected from silica such as fumed silica or treated fumed silica, clays such as bentonite, polyester block co-polymer, ethylene/vinyl acetate copolymer, ethylene/acrylic acid copolymer, sorbitol/sebacic acid copolymer behenate, dextrin palmitate, stearoyl inulin, thickened oil gels, poly C10-30 alkyl acrylates, styrene and ethylene/propylene diblock copolymer, hydrogenated castor oil, polyamide or combinations thereof. In a preferred embodiment, the composition comprises clay as a rheology modifier. In a preferred embodiment, the composition comprises polyester block co-polymer as a rheology modifier. In a preferred embodiment, the composition comprises fumed silica as a rheology modifier.

In a preferred embodiment, the composition comprises an optional rheology modifier in a range of about 0.1% w/w to about 20% w/w. In another preferred embodiment, the composition comprises optional rheology modifier in a range of about 0.5% w/w to about 10% w/w. In still another preferred embodiment, the composition comprises optional rheology modifier in a range of about 1% w/w to about 5% w/w. In a more preferred embodiment, the composition comprises optional rheology modifier in a range of about 1% w/w to about 5% w/w.

In a more preferred embodiment, the composition comprises fumed silica, wherein fumed silica is present in the composition in a range of about 0.1% w/w to about 20% w/w. In another preferred embodiment, the composition comprises fumed silica, wherein fumed silica is present in the composition in a range of about 0.5% w/w to about 10% w/w. In still another preferred embodiment, the composition comprises fumed silica, wherein fumed silica is present in the composition in a range of about 1% w/w to about 5% w/w. In a more preferred embodiment, the composition comprises hydrophobic fumed silica after-treated with DDS. (dimethyldichlorosilane), hydrophobic fumed silica after-treated with DDS. (dimethyldichlorosilane) is present in the composition in a range of about 1% w/w to about 5% w/w.

In at least one embodiment, the compositions of the present disclosure may optionally comprise one or more polymers. Alternatively, the one or more polymers may be applied either simultaneously or applied sequentially, with the biopesticides disclosed herein. Non-limiting uses of polymers in the agricultural industry include agrochemical delivery (e.g., use as an aqueous dispersant), heavy metal removal, water retention and/or water delivery, and combinations thereof. Pouci, et al, Am. J. Agri. & Biol. Sci., 3 (7): 299-314 (2008). In one embodiment, the one or more polymers is a natural polymer (e.g., agar, starch, alginate, pectin, cellulose, etc.), a synthetic polymer, a biodegradable polymer (e.g., polycaprolactone, polylactide, poly(vinyl alcohol), etc.), or a combination thereof.

In another embodiment, the composition further comprises an optional anionic surfactant. Alkyl sulfates, alkyl ether sulfates, alkyl amido ether sulfates, alkyl aryl polyether sulfates, alkyl aryl sulfates, alkyl aryl sulfonates, monoglyceride sulfates, alkyl sulfonates, alkyl amide sulfonates, alkyl aryl sulfonates, benzene sulfonates, toluene sulfonates, xylene sulfonates, cumene sulfonates, alkyl benzene sulfonates, alkyl diphenyloxide sulfonate, alpha-olefin sulfonates, alkyl naphthalene sulfonates, paraffin sulfonates, lignin sulfonates, alkyl sulfosuccinates, ethoxylated sulfosuccinates, alkyl ether sulfosuccinates, alkylamide sulfosuccinates, alkyl sulfosuccinamate, alkyl sulfoacetates, alkyl phosphates, phosphate ester, alkyl ether phosphates, acyl sarconsinates, acyl isethionates, N-acyl taurates, N-acyl-N-alkyltaurates, and alkyl carboxylates. The anionic surfactant may be selected from linear dodecylbenzene sulfonate calcium salt, polyoxyethylene alkyl ether phosphate, polyoxyethylene branched tridecyl phosphate, mixture of calcium alkylarylsulphonate and ethylhexanol. In another embodiment, the anionic surfactant may be present in an amount ranging from about 0.1% w/w to about 20% w/w. In another embodiment, the anionic surfactant may be present in an amount ranging from about 0.5% w/w to about 10% w/w. In another preferred embodiment, the anionic surfactant may be present in an amount ranging from about 1% w/w to about 5% w/w.

In an embodiment, the present disclosure provides a stable non-aqueous composition comprising:
a) an entomopathogenic fungus or spores thereof in an amount ranging from about 0.1% w/w to about 30% w/w of the total weight of the composition;
b) a vegetable oil in an amount ranging from about 10% w/w to about 99.8% w/w of the total weight of the composition; and
c) at least two non-ionic surfactants in an amount ranging from about 0.1% w/w to about 60% w/w of the total weight of the composition, wherein the non-ionic surfactants have a hydrophilic-lipophilic balance (HLB) value of 15 or less than 15.

In an embodiment, the present disclosure provides a stable non-aqueous composition comprising:
a) Beauveria bassiana or spores thereof;
b) a vegetable oil; and
c) a combination of a water insoluble non-ionic surfactant and a non-ionic polymeric surfactant, wherein the water insoluble non-ionic surfactant and the non-ionic polymeric surfactant have an HLB value in the range of 4 and 12.

In a preferred embodiment, the non-aqueous composition is an oil dispersion.

In a preferred embodiment, the water insoluble non-ionic surfactant has an HLB value in the range of 8 to 12.

In a preferred embodiment, the non-ionic polymeric surfactant has an HLB value in the range of 4 to 8.

In a preferred embodiment, the vegetable oil is sunflower oil.

In a preferred embodiment, the non-ionic surfactant is selected from polyoxyethylene sorbitol hexaoleate, polyisobutylene succinic anhydride-polyethylene glycol, or a combination thereof. In an embodiment, polyoxyethylene sorbitol hexaoleate and polyisobutylene succinic anhydride-polyethylene glycol have an HLB value in the range of 4 to 12.

In an embodiment, the weight ratio of polyoxyethylene sorbitol hexaoleate to polyisobutylene succinic anhydride-polyethylene glycol ranges from about 1:10 to about 10:1 in the composition.

The compositions of the present disclosure can be of any form so long as the composition is able to support the desired activity (effective amount) of the fungal pesticide (entomopathogenic fungus or spores thereof), regardless of form (e.g., vegetative state or dormant state), and the composition can be applied to control a target pest.

In an embodiment, the present disclosure provides a method of preparing a stable non-aqueous composition, wherein said method comprising the steps of:
i) Mixing a vegetable oil and at least two non-ionic surfactants having a hydrophilic-lipophilic balance (HLB) value of 15 or less than 15 under high shear;
ii) Adding an entomopathogenic fungus or spores thereof to the mixture obtained in step i);
iii) Homogenizing the mixture of step ii) to obtain a stable composition.

In an embodiment, said method comprises adding an optional rheology modifier or an optional anionic surfactant under high shear to the mixture obtained in step i), prior to addition of entomopathogenic fungus or spores thereof.

In some embodiments, the composition is prepared as a premix composition. In some embodiments, the composition is prepared by admixing the fungal spores and the constituents including oil, surfactants and other optional ingredients extemporaneously to the application. In alternative embodiments, the composition is prepared by admixing the fungal spores, oil, surfactants and other optional ingredients substantially prior to the application of the composition at the target site or pest.

An embodiment of the present disclosure provides an oil dispersion obtainable by a method comprising:
i) Mixing a vegetable oil and at least two non-ionic surfactants having a hydrophilic-lipophilic balance (HLB) value of 15 or less than 15 under high shear;
ii) Adding an entomopathogenic fungus or spores thereof to the mixture obtained in step i);
iii) Homogenizing the mixture of step ii) to obtain a stable composition.

In an embodiment, said method comprises adding an optional rheology modifier or an optional anionic surfactant under high shear to the mixture obtained in step i), prior to addition of entomopathogenic fungus or spores thereof.

The entomopathogenic fungus or spores thereof may be produced in a liquid culture media or a solid culture media fermentation process. The media may have high carbon and nitrogen concentrations to facilitate higher yields. Not-limiting examples of suitable nitrogen sources include hydrolyzed casein, yeast extract, hydrolyzed soy protein, hydrolyzed cottonseed protein, and hydrolyzed corn gluten protein. Not-limiting examples of suitable carbon sources include carbohydrates, including glucose, fructose, and sucrose, and glycerol and/or grains such as rice or barley.

Fermentation processes may be conducted using conventional fermentation processes, such as, aerobic liquid-culture techniques, shake flask cultivation, and small-scale or large-scale fermentation (e.g., continuous, batch, fed-batch, solid state fermentation, etc.) in laboratory or industrial fermentors, and such processes are well known in the art. Notwithstanding the production process used to produce the entomopathogenic fungus or spores thereof, it is envisioned that the entomopathogenic fungus or spores thereof may be used as a pesticide directly from the culture medium or subject to purification and/or further processing steps (e.g., a drying process). In one embodiment, following fermentation, the entomopathogenic fungus or spores thereof may be recovered using conventional techniques (e.g., by filtration, centrifugation, mechanical recovery (e.g., shaking the entomopathogenic fungus or spores thereof from the culture medium), etc.). The entomopathogenic fungus or spores thereof may alternatively be dried (e.g., air-drying, freeze drying, or spray drying to a low moisture level, and storing at a suitable temperature, e.g., room temperature).

The components of the composition (i.e., the spores and the emulsion) may be provided in a kit, contained in a single container or preferably in separate containers. The user can choose to mix the components to make the composition extemporaneously to the application, or the user may choose to mix the components to make the composition substantially prior to the application and store the composition for a period of time that does not affect the stability and infectivity of the composition until application.

In an embodiment, the present disclosure provides a method of improving the storage stability and viability of an entomopathogenic fungus or spores thereof comprising preparing a non-aqueous composition comprising:
a) an entomopathogenic fungus or spores thereof;
b) a vegetable oil; and
c) at least two non-ionic surfactants, wherein the non-ionic surfactants have a hydrophilic-lipophilic balance (HLB) value of 15 or less than 15.

In an embodiment, additional agriculturally beneficial ingredients (e.g., beneficial microbes, signal molecules, insecticides, fungicides, nematicides, and combinations thereof) may also be used in combination with the composition described herein, including as part of the same composition or applied as a separate treatment.

Disclosed herein are also methods for controlling pests. In an embodiment, the method comprises contacting one or more plant pest with a composition comprising:
a) an entomopathogenic fungus or spores thereof;
b) a vegetable oil; and
c) at least two non-ionic surfactants, wherein the non-ionic surfactants have a hydrophilic-lipophilic balance (HLB) value of 15 or less than 15.

In an embodiment, the composition is applied at about 0.1 to 50 L/ha.

In another embodiment, methods of using the compositions disclosed herein to control one or more pests are disclosed. In a preferred embodiment, the method comprises controlling one or more plant pests. Non-limiting examples of plant pests include:

### Hemiptera Harmful Insects:

Planthoppers (Delphacidae) such as small brown planthopper (Laodelphax striatellus), brown rice planthopper (Nilaparvata lugens), white-backed rice planthopper (Sogatella furcifera) and the like; leafhoppers (Deltocephalidae) such as green rice leafhopper (Nephotettix cincticeps), green rice leafhopper (Nephotettix virescens) and the like; aphids (Aphididae) such as cotton aphid (Aphis gossypii), green peach aphid (Myzus persicae), cabbage aphid (Brevicoryne brassicae), potato aphid (Macrosiphum euphorbiae), foxglove aphid (Aulacorthum solani), oat bird-cherry aphid (Rhopalosiphum padi), tropical citrus aphid (Toxoptera citricidus) and the like; stink bugs (Pentatomidae) such as green stink bug (Nezara antennata), bean bug (Riptortus clavetus), rice bug (Leptocorisa chinensis), white spotted spined bug (Eysarcoris parvus), stink bug (Halyomorpha mista), tarnished plant bug (Lyus lineolarxs) and the like; whiteflies (Aleyrodidae) such as greenhouse whitefly (Trialeurodes vaporariorum), sweetpotato whitefly (Bemisia tabaci), silverleaf whitefly (Bemisia argentifolii) and the like; scales (Coccidae) such as California red scale (Aonidiella aurantii), San Jose scale (Comstockaspis perniciosa), citrus north scale (Unaspis citri), red wax scale (Ceroplastes rubens), cottonycushion scale (Icerya purchasi) and the like; lace bugs (Tingidae); psyllids (Psyllidae); etc.

### Lepidoptera Harmful Insects:

Pyralid moths (Pyralidae) such as rice stem borer (Chilo suppressalis), yellow rice borer (Tryporyza incertulas), rice leafroller (Cnaphalocrocis medinalis), cotton leafroller (Notarcha derogata), Indian meal moth (Plodia interpunctella), oriental corn borer (Ostrinia furnacalis), European corn borer (Ostrinia nubilaris), cabbage webworm (Hellula undalis), bluegrass webworm (Pediasia teterrellus) and the like; owlet moths (Noctuidae) such as common cutworm (Spodoptera litura), beet armyworm (Spodoptera exigua), armyworm (Pseudaletia separata), cabbage armyworm (Mamestra brassicae), black cutworm (Agrotis ipsilon), beet semi-looper (Plusia nigrisigna), Thoricoplusia spp., Heliothis spp., Helicoverpa spp. and the like; white butterflies (Pieridae) such as common white (Pieris rapae) and the like; tortricid moths (Tortricidae) such as Adoxophyes spp., oriental fruit moth (Grapholita molesta), soybean pod borer (Leguminivora glycinivorella), azuki bean podworm (Matsumuraeses azukivora), summer fruit tortrix (Adoxophyes orana fasciata), smaller tea tortrix (Adoxophyes spp.), oriental tea tortrix (Homona magnanima), apple tortrix (Archips fuscocupreanus), codling moth (Cydia pomonella) and the like; leafblotch miners (Gracillariidae) such as tea leafroller (Caloptilia theivora), apple leafminer (Phyllonorycter ringoneella) and the like; Carposinidae such as peach fruit moth (Carposina niponensis) and the like; lyonetiid moths (Lyonetiidae) such as Lyonetia spp, and the like; tussock moths (Lymantriidae) such as Lymantria spp., Euproctis spp, and the like; yponomeutid moths (Yponomeutidae) such as diamondback (Plutella xylostella) and the like; gelechiid moths (Gelechiidae) such as pink bollworm (Pectinophora gossypiella), potato tubeworm (Phthorimaea operculella) and the like; tiger moths and allies (Arctiidae) such as fall webworm (Hyphantria cunea) and the like; tineid moths (Tineidae) such as casemaking clothes moth (Tinea translucens), webbing clothes moth (Tineola bisselliella) and the like; etc.

### Thysanoptera Harmful Insects:

Thrips (Thripidae) such as western flower thrips (Frankliniella occidentalis), melon thrips (Thrips palmi), yellow tea thrips (Scirtothrips dorsalis), onion thrips (Thrips tabaci), flower thrips (Frankliniella intonsa), tobacco thrips (Frankliniella fusca) and the like, etc.;

### Diptera Harmful Insects:

House flies (Musca domestica), common house mosquito (Culex popiens pallens), horsefly (Tabanus trigonus), onion fly (Hylemya antiqua), seedcorn maggot (Hylemya platura), asian tiger mosquito (Anopheles sinensis); leafminer flies (Agromyzidae) such as rice leafminer (Agromyza oryzae), little rice leafminer (Hydrellia griseola), rice stemmaggot (Chlorops oryzae), legume leafminer (Liriomyza trifolii) and the like; melon fly (Dacus cucurbitae), Meditteranean fruit fly (Ceratitis capitata), etc.;

### Coleoptera Harmful Insects:

Twenty-eight-spotted ladybird (Epilachna vigintioctopunctata), cucurbit leaf beetle (Aulacophora femoralis), striped flea beetle (Phyllotreta striolata), rice leaf beetle (Oulema oryzae), rice curculio (Echinocnemus squameus), rice water weevil (Lissorhoptrus oryzophilus), boll weevil (Anthonomus grandis), azuki bean weevil (Callosobruchus chinensis), hunting billbug (Sphenophorus venatus), Japanese beetle (Popxllia japonica), cupreous chafer (Anomala cuprea), Corn root worms (Diabrotica spp.), Colorado potato beetle {Leptinotarsa decemlineata), click beetles (Agriotes spp.), cigarette beetle (Lasioderma serricorne), varied carper beetle (Anthrenus verbasci), red flour beetle (Tribolium castaneum), powder-post beetle (Lyctus brunneus), white-spotted longicorn beetle (Anoplophora malasiaca), pine shoot beetle (Tomicus piniperda), etc.;

### Orthoptera Harmful Insects:

Asiatic locust (Locusta migratoria), African mole cricket (Gryllotalpa africana), rice grasshopper (Oxya yezoensis), rice grasshopper (Oxya japonica), etc.;

### Hvmenoptera Harmful Insects:

Cabbage sawfly (Athalia rosae), leaf-cutting ant (Acromyrmex spp.), fire ant {Solenopsis spp.), etc.;

### Blattodea Harmful Insects:

German cockroach (Blattella germanica), smokybrown cockroach (Periplaneta fuliginosa), American cockroach (Periplaneta americana), Periplaneta brunnea, oriental cockroach (Blatta orientalis), etc.

Particular examples of the above-described harmful arthropods include aphids (Aphididae), Thrips (Thripidae), leafminer flies (Agromyzidae), horsehair worms (Paragordius tricuspidatus), Colorado potato beetle (Leptinotarsa decemlineata), Japanese beetle (Popillia japonica), cupreous chafer (Anomala cuprea), boll weevil (Anthonomus grandis), rice water weevil (Lissorhoptrus oryzophilus), tobacco thrips (Frankliniella fusca), Corn root worms (Diabrotica spp.), diamondback (Plutella xylostella), cabbageworms, soybean pod borer (Leguminivora glycinivorella), and the like.

In a preferred embodiment, the method includes controlling one or more plant pests comprising contacting a plant pest with one or more of the compositions of the present disclosure. The contacting step can be performed by any method known in the art (e.g., spraying, dusting, etc.). In one embodiment, the contacting step is repeated (e.g., more than once, as in the contacting step is repeated twice, three times, four times, five times, six times, seven times, eight times, nine times, ten times, etc.).

In another embodiment, a method for controlling one or more pest comprises contacting the pest or a plant or plant part with one or more of the compositions of the present disclosure. Without being bound by theory, it is believed the one or more pests, e.g., plant pests, will come in contact with the compositions disclosed herein when in contact with a treated plant or plant part. In an embodiment, the contacting step can be performed by any method known in the art (including both foliar and non-foliar applications). Non-limiting examples of contacting the plant or plant part include spraying the plant or plant part, drenching the plant or plant part, dripping onto the plant or plant part, dusting the plant or plant part, and/or coating a seed with one or more of the compositions of the present disclosure. In one embodiment, the contacting step is repeated (e.g., more than once, as in the treating step is repeated twice, three times, four times, five times, six times, seven times, eight times, nine times, ten times, etc.). The contacting step can occur at any time during the growth of the plant or plant part. In one embodiment, contacting a plant or plant part with one or more of the compositions of the present disclosure occurs before the plant or plant part begins to grow. In another embodiment, contacting a plant or plant part with one or more of the compositions of the present disclosure occurs after the plant or plant part has started to grow.

In another embodiment, the method further comprises the step of treating the soil or a locus with the compositions of the present disclosure. The planting step can occur before, after or during the treatment of the soil with one or more of the compositions of the present disclosure. In one embodiment, the planting step occurs before the soil is treated with one or more of the compositions described herein. In another embodiment, the planting step occurs during the treatment of the soil with one or more of the compositions of the present disclosure (e.g., the planting step occurs substantially simultaneous with the treating step, etc.). In still another embodiment, the planting step occurs after the soil is treated with one or more of the compositions of the present disclosure.

In another embodiment, seeds are coated with one or more of the compositions of the present disclosure. In one embodiment, seeds may be treated with composition described herein in several ways, for example via spraying or dripping. Spray and drip treatment may be conducted by formulating compositions of the present disclosure and spraying or dripping the compositions of the present disclosure onto a seed(s) via a continuous treating system (which is calibrated to apply treatment at a predefined rate in proportion to the continuous flow of seed), such as a drum-type of treater. Batch systems, in which a predetermined batch size of seed and composition(s) as described herein are delivered into a mixer, may also be employed. In another embodiment, the treatment entails coating seeds. In an embodiment, further disclosed are seeds coated with compositions of the present disclosure.

In an embodiment, the compositions of the present disclosure may be used to control pests in agricultural as well as non-agricultural areas. In an embodiment, the compositions of the present disclosure may be used to control pests in agricultural crops. In an embodiment, the compositions of the present disclosure may be used to control pests in non-agricultural plants.

The compositions of the present disclosure may be applied at varying concentrations to perform any of the methods disclosed or to any of the seed coatings or methods of coating seeds described herein. In an embodiment, the compositions of the present disclosure are diluted with water. In an embodiment, the compositions of the present disclosure are applied at a rate of about 0.1 to about 20 kg/ha.

The present invention will be further illustrated in the following examples. However, it is to be understood that these examples are for illustrative purposes only and should not be used to limit the scope of the present invention in any manner.

### EXAMPLES

### Example 1

An oil dispersion composition comprising spores of Beauveria bassiana according to the present disclosure is prepared as follows:

TABLE 1
Oil dispersion composition comprising
spores of Beauveria bassiana

| Ingredient | % w/w |
|---|---|
| Sunflower Oil | 73.37 |
| Polyoxyethylene (40) sorbitol hexaoleate | 20.00 |
| Polyisobutylene succinic anhydride-polyethylene | 2.00 |
| glycol | |
| Fumed silica | 2.00 |
| Beauveria bassiana spores | 2.63 |
| Total | 100.00 |

The composition was prepared by mixing sunflower oil and the two non-ionic surfactants. Fumed silica was added under high shear and mixed until homogenous. Beauveria bassiana spores were added to the homogenous mixture thus obtained and it was further homogenized to obtain a stable oil dispersion.

### Example 2

Comparative stability assessment of oil-surfactant systems.

18 compositions of oil and surfactants were prepared without active ingredient (except composition no. 5 and 9) to assess the stability of the compositions over a period of 15 hours. The compositions 1-18 are described in Table 2.

TABLE 2
Comparative stability analysis of oil-surfactant systems

| Composition | | Amount | Function of | HLB | |
|---|---|---|---|---|---|
| No. | Component | % w/w | component | value | Stability |
| 1 | Sunflower oil | 80 | oil | NA | Stable |
| | Polyoxyethylene (40) sorbitol | 15 | non-ionic | 10 | |
| | hexaoleate | | surfactant | | |
| | Ethylene Oxide/Propylene | 5 | non-ionic | 15 | |
| | Oxide (EO/PO) Copolymers | | surfactant | | |
| 2 | Sunflower oil | 80 | oil | NA | Stable |
| | Polyoxyalkylene glycol fatty | 15 | non-ionic | 10 | |
| | alcohol ether | | surfactant | | |
| | Castor oil ethoxylate with 40 | 5 | non-ionic | 14 | |
| | EO | | surfactant | | |
| 3 | Sunflower oil | 79 | oil | NA | Stable |
| | Fumed silica | 1 | rheology | NA | |
| | | | modifier | | |
| | Polyisobutylene succinic | 5 | non-ionic | 6 | |
| | anhydride-polyethylene | | surfactant | | |
| | glycol | | | | |
| | alkoxylated | 15 | non-ionic | 12 | |
| | diethylethanolamine | | surfactant | | |
| | (Polyoxyethylene (12) | | | | |
| | Diethyl ethanol amine mono- | | | | |
| | trimerate) | | | | |
| 4 | Sunflower oil | 79 | oil | NA | Stable |
| | Fumed silica | 1 | rheology | NA | |
| | | | modifier | | |
| | Polyisobutylene succinic | 5 | non-ionic | 6 | |
| | anhydride-polyethylene | | surfactant | | |
| | glycol | | | | |
| | Polyoxyethylene (40) sorbitol | 15 | non-ionic | 10 | |
| | hexaoleate | | surfactant | | |
| 5 | Sunflower oil | 81 | oil | NA | Stable |
| | Polyoxyethylene (40) sorbitol | 16 | non-ionic | 10 | |
| | hexaoleate | | surfactant | | |
| | Butanol PO(31) EO(31) block | 2 | non-ionic | 12 | |
| | copolymer | | surfactant | | |
| | Spores of Beauveria bassiana | 1 | active | NA | |
| | | | ingredient | | |
| 6 | Sunflower oil | 79 | oil | NA | Unstable |
| | Fumed silica | 1 | rheology | NA | |
| | | | modifier | | |
| | Polyisobutylene succinic | 5 | non-ionic | 6 | |
| | anhydride-polyethylene | | surfactant | | |
| | glycol | | | | |
| | (Polyoxyethylene sorbitan | 15 | non-ionic | 16.5 | |
| | monolaurate) | | surfactant | | |
| 7 | Sunflower oil | 80 | oil | NA | Unstable |
| | Polyoxyalkylene glycol fatty | 15 | non-ionic | 10 | |
| | alcohol ether | | surfactant | | |
| | Polyethylene glycol sorbitan | 5 | non-ionic | 16.7 | |
| | monolaurate | | surfactant | | |
| | (Polyoxyethylenesorbitan | | | | |
| | monolaurate) | | | | |
| 8 | Sunflower oil | 80 | oil | NA | Unstable |
| | Polyoxyethylene (40) sorbitol | 15 | non-ionic | 10 | |
| | hexaoleate | | surfactant | | |
| | Polyethylene glycol sorbitan | 5 | non-ionic | 16.7 | |
| | monolaurate | | surfactant | | |
| | (Polyoxyethylenesorbitan | | | | |
| | monolaurate) | | | | |
| 9 | Sunflower oil | 79 | oil | NA | Unstable |
| | Polyoxyethylene alkyl ether | 5 | Anionic | 12 | |
| | phosphate | | surfactant | | |
| | Spores of Beauveria bassiana | 1 | active | NA | |
| | | | ingredient | | |
| | Polyoxyethylene (40) sorbitol | 15 | non-ionic | 10 | |
| | hexaoleate | | surfactant | | |
| 10 | Sunflower oil | 80 | oil | NA | Unstable |
| | Polyoxyethylene (40) sorbitol | 15 | non-ionic | 10 | |
| | hexaoleate | | surfactant | | |
| | Linear dodecylbenzene | 5 | anionic | 9 | |
| | sulfonate calcium salt | | surfactant | | |
| 11 | Sunflower oil | 80 | oil | NA | Unstable |
| | Polyoxyethylene (40) sorbitol | 15 | non-ionic | 10 | |
| | hexaoleate | | surfactant | | |
| | Linear dodecylbenzene | 5 | anionic | 9 | |
| | sulfonate calcium salt | | surfactant | | |
| 12 | Sunflower oil | 90 | oil | NA | unstable |
| | mixture of calcium | 10 | anionic | | |
| | alkylarylsulphonate and | | surfactant | | |
| | ethylhexanol | | | | |
| 13 | Sunflower oil | 90 | oil | NA | unstable |
| | Polyoxyethylene (8) sorbitan | 10 | non-ionic | 15 | |
| | monolaurate | | surfactant | | |
| 14 | Sunflower oil | 90 | oil | NA | unstable |
| | Polyoxyethylene sorbitan | 10 | non-ionic | 16.5 | |
| | monolaurate | | surfactant | | |
| 15 | Sunflower oil | 85 | oil | NA | unstable |
| | Polyoxyethylene (40) sorbitol | 15 | non-ionic | 10 | |
| | hexaoleate | | surfactant | | |
| 16 | Sunflower oil | 85 | oil | NA | unstable |
| | Castor oil ethoxylate with 40 | 15 | non-ionic | 14 | |
| | EO | | surfactant | | |
| 17 | Sunflower oil | 80 | oil | NA | Stable |
| | Polyisobutylene succinic | 5 | non-ionic | 6 | |
| | anhydride-polyethylene | | surfactant | | |
| | glycol | | | | |
| | alkoxylated | 15 | non-ionic | 12 | |
| | diethylethanolamine | | surfactant | | |
| | (Polyoxyethylene (12) | | | | |
| | Diethyl ethanol amine mono- | | | | |
| | trimerate) | | | | |
| 18 | Sunflower oil | 80 | oil | NA | Stable |
| | Polyisobutylene succinic | 5 | non-ionic | 6 | |
| | anhydride-polyethylene | | surfactant | | |
| | glycol | | | | |
| | Polyoxyethylene (40) sorbitol | 15 | non-ionic | 10 | |
| | hexaoleate | | surfactant | | |

From the above table, it was demonstrated that only compositions comprising two non-ionic surfactants with HLB value less than or equal to 15 were found to be stable while other comprising anionic surfactants, single surfactant and non-ionic surfactant with HLB value greater than 15 were found to be unstable. It was further observed that compositions 3, 4, 17 and 18 were the most stable compositions, wherein one non-ionic surfactant had an HLB value less than 8 and other had an HLB value greater than 8. Composition 5 exhibited a good dispersion of spores in the system.

### Example 3

Oil dispersion of Beauveria bassiana spores as per the present disclosure is described in table 3.

TABLE 3

| Ingredient | % w/w |
|---|---|
| Sunflower Oil | 75.00 |
| Sodium dioctyl sulfosuccinate (HLB 10) | 20.00 |
| Polyisobutylene succinic anhydride-polyethylene | 2.00 |
| glycol | |
| hydrophobic fumed silica after-treated with DDS | 2.00 |
| (dimethyldichlorosilane) | |
| Beauveria bassiana spores | 1.00 |

### Example 4

Oil dispersion of Beauveria bassiana spores as per the present disclosure is described in table 4.

TABLE 4

| Ingredient | % w/w |
|---|---|
| Soybean Oil | 75.00 |
| Polyoxyethylene (40) sorbitol hexaoleate | 20.00 |
| Polyisobutylene succinic anhydride-polyethylene | 2.00 |
| glycol | |
| hydrophobic fumed silica after-treated with DDS | 2.00 |
| (dimethyldichlorosilane) | |
| Beauveria bassiana spores | 1.00 |

### Example 5

Oil dispersion of Beauveria bassiana spores as per the present disclosure is described in table 5.

TABLE 5

| Ingredient | % w/w |
|---|---|
| Soybean Oil | 80.00 |
| Polyoxyethylene (40) sorbitol hexaoleate | 15.00 |
| Polyisobutylene succinic anhydride-polyethylene | 2.00 |
| glycol | |
| Polyoxyethylene Branched tridecyl phosphate | 2.00 |
| Beauveria bassiana spores | 1.00 |

### Example 6

Oil dispersion of Beauveria bassiana spores as per the present disclosure is described in table 6.

TABLE 6

| Ingredient | % w/w |
|---|---|
| Soybean Oil | 75.00 |
| Polyoxyalkylene glycol fatty alcohol ether | 20.00 |
| Polyisobutylene succinic anhydride-polyethylene | 2.00 |
| glycol | |
| Polyoxyethylene Branched tridecyl phosphate | 2.00 |
| Beauveria bassiana spores | 1.00 |

1. A stable non-aqueous composition comprising:
(a) an entomopathogenic fungus or spores thereof;
(b) a vegetable oil; and
(c) at least two non-ionic surfactants, wherein the non-ionic surfactants have a hydrophilic-lipophilic balance (HLB) value of 15 or less than 15, wherein the entomopathogenic fungus or spores thereof is in an amount ranging from about 0.1% w/w to about 30% w/w of the total weight of the composition.

2. The stable non-aqueous composition of claim 1, wherein the stable nonaqueous composition is an oil dispersion.

3. The stable non-aqueous composition of claim 1, wherein the entomopathogenic fungus or spores thereof is Beauveria bassiana or spores thereof.

4. (canceled)

5. The stable non-aqueous composition of claim 1, wherein the vegetable oil is selected from olive oil, kapok oil, castor oil, palm oil, sunflower oil, camellia oil, coconut oil, sesame oil, corn oil, rice bran oil, peanut oil, cottonseed oil, soybean oil, rapeseed oil, linseed oil, tung oil, canola oil, corn oil, or combinations thereof.

6. The stable non-aqueous composition of claim 1, wherein the vegetable oil is present in an amount ranging from about 10% w/w to about 99.8% w/w of the total weight of the composition.

7. The stable non-aqueous composition of claim 1, wherein the at least two non-ionic surfactants have a HLB value of 12 or less than 12.

8. The stable non-aqueous composition of claim 7, wherein one of the two nonionic surfactants has HLB value in the range of 8 to 12 and the other non-ionic surfactant has HLB value in the range of 4 to 8.

9. The stable non-aqueous composition of claim 1, wherein the weight ratio of the two non-ionic surfactants in the composition ranges from about 1:100 to about 100:1.

10. The stable non-aqueous composition of claim 1, wherein at least two nonionic surfactants are in an amount ranging from about 0.1% w/w to about 60% w/w of the total weight of the composition.

11. The stable non-aqueous composition of claim 1, wherein the non-ionic surfactants are selected from water soluble non-ionic surfactants, water insoluble non-ionic surfactants, non-ionic polymeric surfactants, or combinations thereof.

12. The stable non-aqueous composition of claim 11, wherein the non-ionic polymeric surfactants are selected from polymeric surfactants selected from polyisobutylene succinic anhydride-polyethylene glycol, polyalkylene oxide block copolymer, polyalkylene glycol ether, polyoxyalkylene glycol fatty alcohol ether, polyoxyethylene alkyl ether, block copolymer of polyethylene glycol and 12-hydroxystearic acid, polymethyl methacrylate-polyethylene glycol graft copolymer, succinic anhydride-polyethylene glycol, polyoxyethylene polyaryl phenol, block copolymer of a poly(12-hydroxystearic acid) and poly(ethylene oxide), block copolymer of a poly(12-hydroxystearic acid) and poly(ethylene oxide) (also known as polyethylene glycol) having molecular weights from 1500 to 10000, alkylbenzenesulphonates, alkanoyl taurates, and alkanoyl sarcosinates, and combinations thereof.

13. The stable non-aqueous composition of claim 11, wherein the water insoluble non-ionic surfactants are selected from alkyl and aryl: glycerol ethers, glycol ethers, ethanolamides, sulfoanylamides, alcohols, amides, alcohol ethoxylates, exthoxylated oil such as castor oil ethoxylates, glycerol esters, glycol esters, ethoxylates of glycerol ester and glycol esters, sugar-based alkyl polyglycosides, polyoxyethylenated fatty acids, alkanolamine condensates, alkanolamides, tertiary acetylenic glycols, polyoxyethylenated mercaptans, carboxylic acid esters, polyoxyethylenated polyoxyproylene glycols, sorbitan fatty acid esters, sorbitol ethoxylate esters, EO/PO block copolymers (EO is ethylene oxide, PO is propylene oxide), EO polymers and copolymers, polyamines, polyvinylpyrrolidones, sulfosuccinates such as sodium dioctyl sulfosuccinate, and combinations thereof.

14. The stable non-aqueous composition of claim 11, wherein the water-soluble non-ionic surfactants are selected from sorbitan fatty acid alcohol ethoxylates, alkoxylated diethylethanolamine, sorbitan fatty acid ester ethoxylates, and combinations thereof.

15. The stable non-aqueous composition of claim 1, wherein the composition further comprises an optional rheology modifier or an optional anionic surfactant.

16. The stable non-aqueous composition of claim 1, wherein said composition is a biopesticidal composition.

17. A method of improving the storage stability and viability of the entomopathogenic fungus or spores thereof comprising preparing a stable nonaqueous composition of claim 1.

18. A method of preparing a stable non-aqueous composition of claim 1, wherein said method comprising the steps of:
(i) mixing a vegetable oil and at least two non-ionic surfactants having a HLB value of 15 or less than 15 under high shear;
(ii) adding an entomopathogenic fungus or spores thereof to the mixture obtained in step i);
(iii) homogenizing the mixture of step ii) to obtain a stable composition.

19. A method of preparing a stable non-aqueous composition of claim 18, wherein the method comprises optionally adding a rheology modifier or an anionic surfactant under high shear to the mixture obtained in step i), prior to addition of the entomopathogenic fungus or spores thereof.

20. A method of controlling plant pests comprising contacting one or more plant pests or a locus with a stable non-aqueous composition of claim 1.
